(19) United States
(12) Patent Application Publication
(10) Pub. No.: US 2010/0145867 A1
(43) Pub. Date: Jun. 10, 2010

(54) VERIFICATION METHOD

(76) Inventors: Mark Robert Fowkes, West Bridgford, Nottingham (GB); James Christopher Butcher, Bottesford, Nottinghamshire (GB)

Correspondence Address: Danaher Product ID, 1500 Mittel Blvd, Wood Dale, IL, 60191, US

(21) Appl. No.: 12/513,636

(22) PCT Filed: Oct. 31, 2007
(86) PCT No.: PCT/GB07/04147

§ 371 Date: Nov. 2, 2009

(30) Foreign Application Priority Data
Nov. 7, 2006 (GB) 0622164.2
Jul. 23, 2007 (GB) 0714319.1

(51) Int. Cl. G06Q 99/00; G06F 3/048; G06F 17/00; G06K 19/06

(52) U.S. Cl. 705/318; 715/810; 235/375

(57) ABSTRACT

A computer-implemented method of verifying the authenticity of a product. The method comprises receiving an identification code associated with said product, and receiving at least one data item, the or each data item relating to a respective characteristic of said product. Said identification code is processed to determine at least one characteristic associated with said identification code; and output data indicating the authenticity of said product is generated by processing said at least one data item relating to a characteristic of said product and said at least one characteristic associated with said identification code.

The present invention relates to a verification method, and more particularly to a method of verifying the authenticity of a product such as a consumer product.

It is known that the production and distribution of counterfeit goods is an enormous problem which affects a wide range of goods.

Heretofore, various methods for the detection of counterfeit goods have been proposed. In general terms, some of these methods involve the inclusion of a security (or identification) code on items or on packaging associated with such items. Such security codes typically take the form of an alphanumeric string. In order to determine whether a particular item is a genuine item or a counterfeit item, a consumer or brand owner or retailer enters the security code into a verification system (for example via the Internet). The verification system uses algorithms to process the input security code and also uses certain information stored in a database, in order to determine whether the input security code is valid and therefore whether the item to which it is applied is a genuine item. The consumer or brand owner or retailer is then informed appropriately.

WO 00/23954 (Elliott) describes a verification method of the general type described above. In the verification method of Elliott a security code is generated by encrypting both public data applied to an item (e.g. a batch number) and private data known both to the generator of the security code and to a verifier. In order to carry out verification, a user inputs a security code into a verification system together with predetermined public data (e.g. the batch number) appearing on the goods. The verification system then encrypts the input public data together with the stored private data to generate a verification code which is compared with the security code to determine whether the processed item is a genuine or counterfeit item.

It is described in WO 00/23954 that it is advantageous that a unique security code is applied to each item, given that the use of unique security codes improves the robustness of the counterfeit detection method.

The application and verification of security codes as described above is an obstacle to counterfeit activity. However, producers of counterfeit products are sometimes able to obtain valid security codes and apply such codes to counterfeit products, thereby overcoming the obstacle presented by such codes.

It is an object of embodiments of the present invention to obviate or mitigate one or more of the problems outlined above.

According to a first aspect of the present invention, there is provided a method and apparatus for verifying the authenticity of a product. The method comprises receiving an identification code associated with said product; receiving at least one data item, the or each data item relating to a respective characteristic of said product; processing said identification code to determine at least one characteristic associated with said identification code; and generating output data indicating the authenticity of said product by processing said at least one data item relating to a characteristic of said product and, said at least one characteristic associated with said identification code.

The present invention therefore allows the authenticity of a product to be verified by processing data items relating to product characteristics. In this way, any third party attempting to create counterfeit products would need to match all such characteristics if the counterfeit product was to verify as authentic. The present invention therefore provides a verification method which is robust and secure.

The characteristic of the product may be a characteristic of packaging of said product.

The method may further comprise providing prompt data indicating at least one required data item, and receiving the at least one data item in response to said prompt data. The prompt data may take any convenient form, for example, the prompt data may take the form of a question.

Each data item may be associated with a respective prompt data item, each prompt data item comprising a plurality of user selectable options. The or each data item may be generated by user selection of an option associated with a respective one of said at least one prompt data items.

Processing the identification code to determine at least one characteristic associated with the identification code may comprise obtaining said at least one characteristic from a database. Obtaining said at least one characteristic from a database may comprise performing a database lookup operation using said identification code.

Alternatively, obtaining said at least one characteristic from a database may comprise obtaining a product group identifier using said identification code, and performing a database lookup operation using said product group identifier. The product group identifier may be a batch identifier. Obtaining the product group identifier using said identification code may comprise algorithmically deriving said product group identifier from said identification code.

The output data may indicate that said product is authentic if but only if the or each data item relating to a respective characteristic of said product matches a corresponding characteristic associated with the identification code.

The data items can take any convenient form. In some embodiments of the invention the data items take the form of answers to provided questions. At least one data item may relate to a colour of the product, a part of the product, packaging of the product, or a part of packaging of the product. One data item may relate to a form of graphical data printed on or affixed to the product. The graphical data may comprise a hologram, and the data item may comprise data describing said hologram. The graphical data may comprise textual data, and the data item may relate to formatting of said textual data, for example, the presence or absence of punctuation within predetermined textual data.

The product may include an interference pattern arranged to form an image, for example a holographic image. The image may comprise the identification code. The at least one data item may relate to a characteristic of said image. The interference pattern may be produced in any convenient way, for example by irradiation of a substrate. The irradiation may be laser irradiation.

The method may further comprise processing said identification code to validate said identification code. Processing said identification code may comprise decrypting at least part of said identification code. If the processing determines that said identification code is valid said output data may be generated by said processing of said at least one data item relating to a characteristic of said product and said at least one characteristic associated with said identification code, or if said processing determines that said identification code is not valid, output data may be generated based upon said validating.

A further aspect of the present invention provides a method and apparatus for verifying a product having associated packaging, the packaging having graphical information of a first form printed thereon or affixed thereto, and the product having an associated identification code. The method comprises processing said identification code to obtain data indicating a second form for graphical data; and providing said data indicating a second form for graphical data to allow verification of said product by comparison of said graphical data of said first form with said data indicating said second form for graphical data.

Graphical data having said first form and graphical data having said second form may be the same. Data indicating a second form for graphical data may comprise graphical data having said second form. Alternatively or additionally, data indicating a second form for graphical data may comprise textual data describing said second form for graphical data. The graphical data may comprise textual data.

A further aspect of the present invention provides a method and apparatus for storing data for use in verification operations. The method comprises storing in a database an identifier of a product or group of products; and storing in said database data relating to characteristics of said product, or each product in said group of products. Data relating to characteristics of said product or each product in said group of products is accessible by reference to said identifier.

In this way, a database is created which can be queried using an appropriate identifier, so as to allow verification operations based upon that identifier to take appropriate product characteristics into account.

The group of products may be a batch of products, such that said identifier is a batch identifier.

Data relating to characteristics of said product may comprise a plurality of prompt data items, each prompt data items being associated with a plurality of related data items, and data indicating one of said data items which specifies a characteristic of said product or each product in said group of products.

Aspects of the invention can be implemented in any convenient way, including by way of suitable methods and apparatus. Aspects of the invention can also be implemented using a suitably programmed computer or a suitable arrangement of networked computers. Aspects of the invention provide bespoke hardware. Such hardware can take the form of a standalone bespoke hardware or alternatively a bespoke hardware module which is usable with other suitable hardware such as a suitably programmed computer. Aspects of the invention also provide appropriate computer programs which can be stored on appropriate carrier media such a tangible carrier media, and communications signals.

Features described and claimed in the context of a particular aspect of the invention can similarly be applied to other aspects of the present invention.

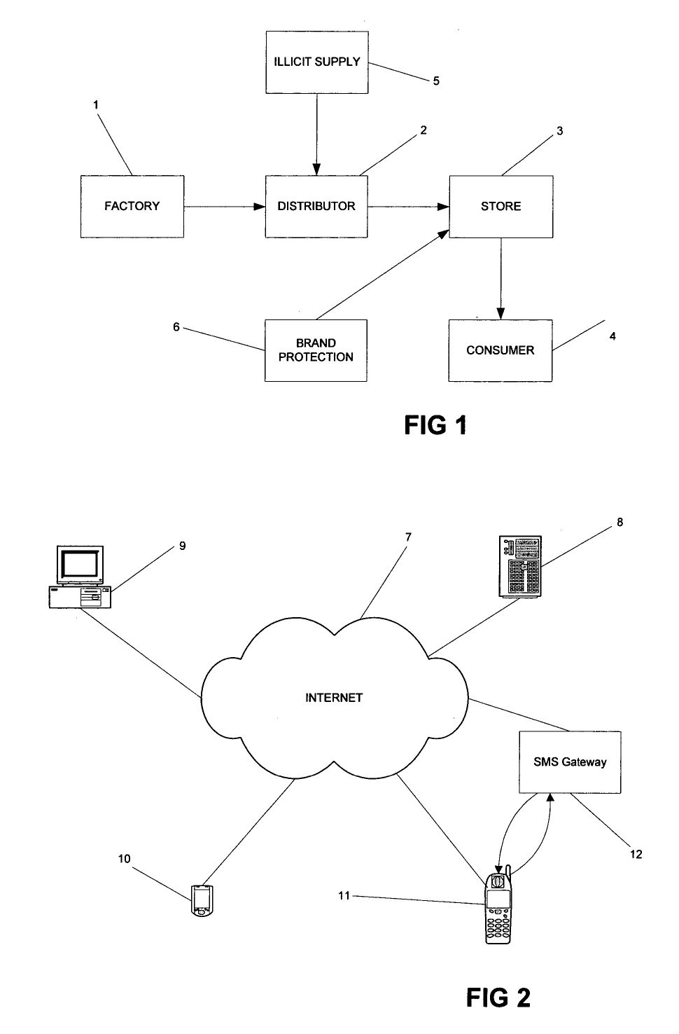

FIG. 1 is a schematic illustration of a product distribution and brand protection process in which embodiments of the invention can be employed;

FIG. 2 is a schematic illustration of a computer network suitable for implementing an embodiment of the present invention;

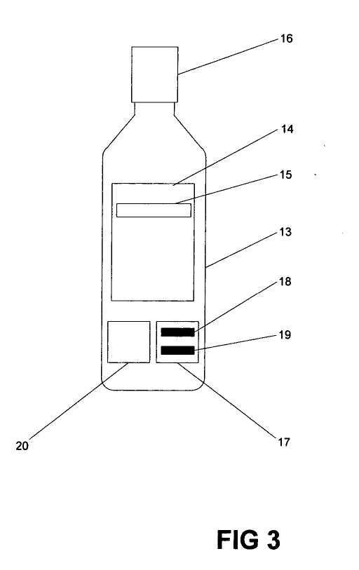

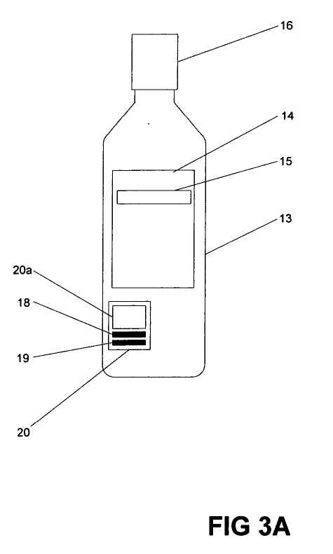

FIG. 3 is a schematic illustration of a product which may be distributed using the process of FIG. 1;

FIG. 3A is a schematic illustration of an alternative product which may be distributed using the process of FIG. 1;

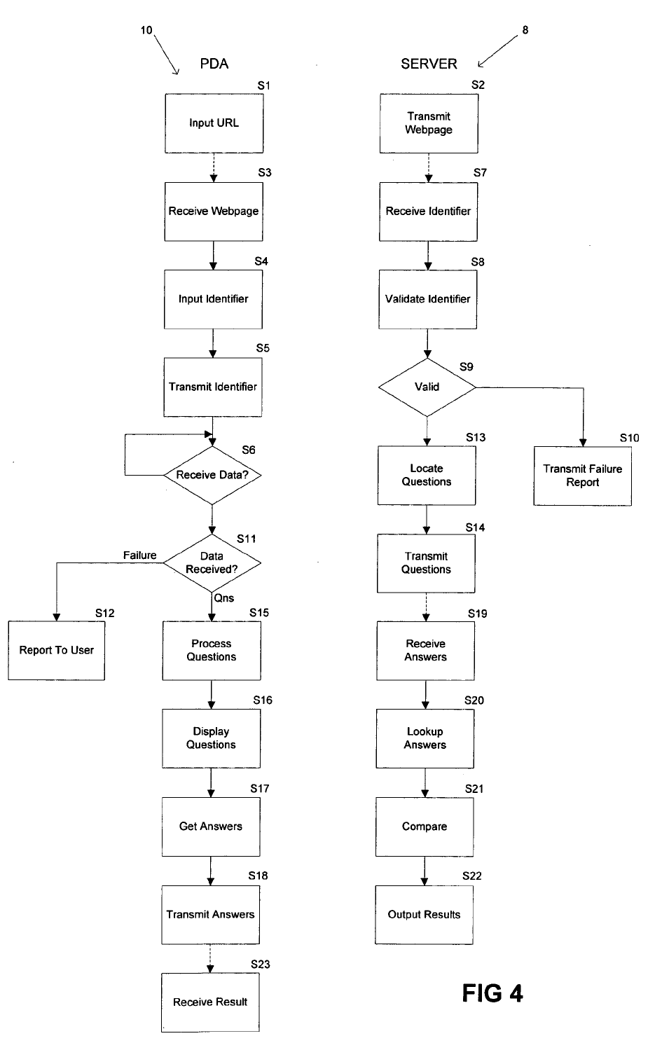

FIG. 4 is a flow chart showing processing carried out in an embodiment of the present invention to verify authenticity of a product;

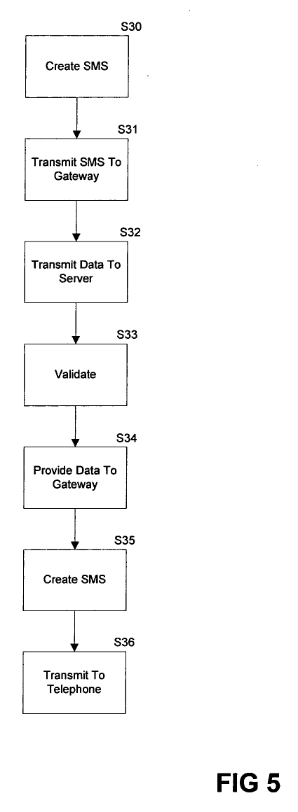

FIG. 5 is a flow chart showing processing carried out in an embodiment of the present invention to verify authenticity of a product using a mobile telephone;

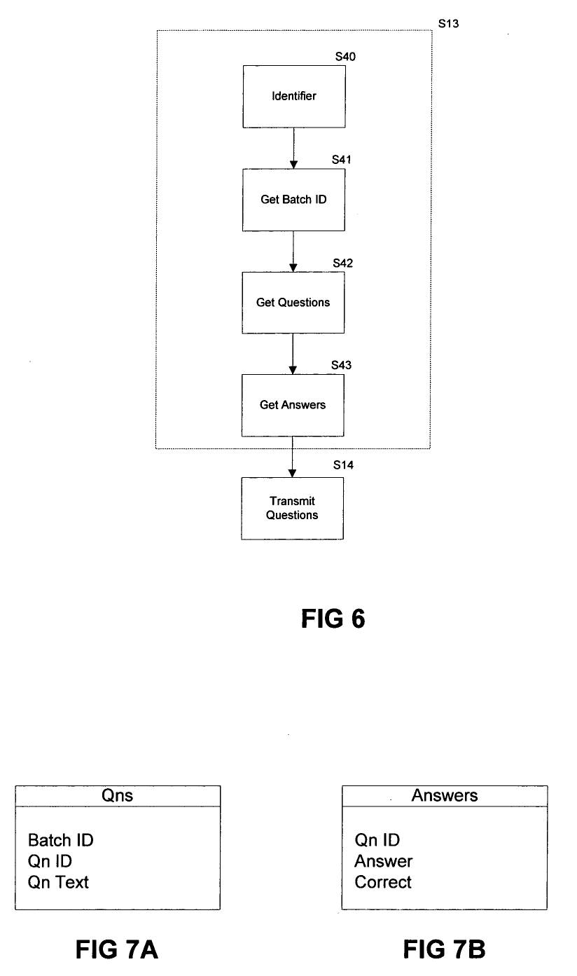

FIG. 6 is a flow chart showing how data is retrieved in embodiments of the present invention;

FIGS. 7A and 7B are schematic illustrations of database tables used in the process of FIG. 6;

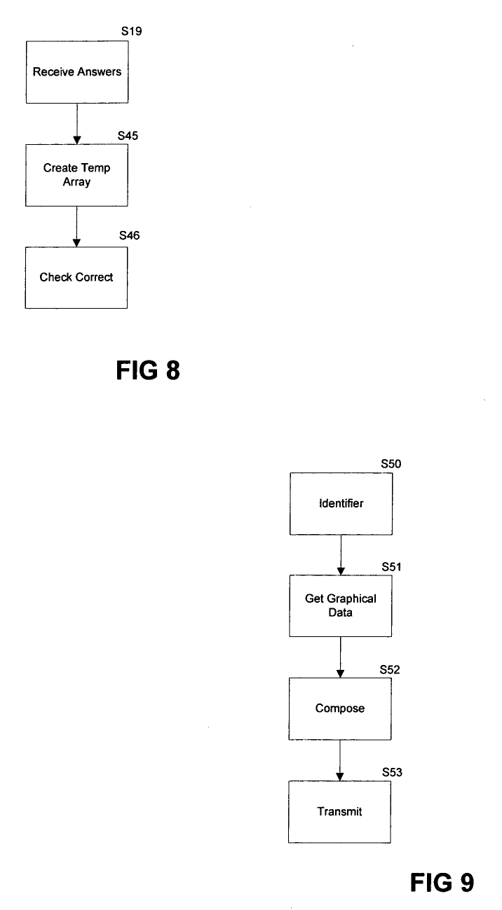

FIG. 8 is a flow chart showing how data is received and processed to verify authenticity in embodiments of the present invention; and

FIG. 9 Is a flow chart showing how data usable in verification operations is retrieved and assembled for display in an embodiment of the invention.

Referring first to FIG. 1, a distribution process for a particular product is shown. It can be seen that products are manufactured and packed at a factory 1, from where they are supplied to a distributor 2. Products are manufactured at the factory 1 under the control of a brand owner, whose brand is affixed to the product or its packaging. It will be appreciated that in many cases products will be provided to a plurality of distributors 2 from the factory 1, and further appreciated that some distributors will themselves distribute products to a plurality of other distributors for onward distribution. That is, although a single distributor 2 is shown in FIG. 1, it will be appreciated that in practice a plurality of distributors will take part in the distribution process, the distributors being arranged in any convenient way to facilitate distribution.

The distributor 2 distributes received products to a store 3 which is one of a plurality of stores selling the products. A consumer 4 is then able to purchase the product from the store 3.

The preceding description shows how products are distributed from a factory 1 to a store 3. However it is often the case that in addition to products distributed through the legitimate supply chain described above, illicit products are also distributed. Such products may be manufactured by an unauthorised third party, or imported by an unauthorised third party. A supply of such products 5 is shown in FIG. 1. This supply may either be received and distributed by the distributor 2 or by another distributor. In both cases, illicit products are supplied to the store 3 and then bought, often unwittingly, by the consumer 4. It will be appreciated that the illicit supply 5 can enter the supply chain through different routes, e.g. by being directly supplied to the store 3.

The supply of illicit products as described above is a potential danger to consumers, who may be supplied with substandard, and in some cases even dangerous products. It is also a problem for brand owners, whose reputation is jeopardised by the uncontrolled illicit supply. For this reason, many brand owners employ brand protection officers 6 who visit appropriate stores in an attempt to ensure that only legitimate products bearing the brand owner's brand are available for sale. In accordance with embodiments of the present invention, the brand protection officers can carry out their checks in a number of ways, some of which are described in further detail below.

FIG. 2 schematically shows a computer network usable by a brand owner and by brand protection officers in scenarios of the type described above. Use of this network is described in further detail below. It can be seen that the network is based upon the Internet 7, to which a plurality of computers are connected. A server 8 operated by the brand owner is connected to the Internet 7, so as to be accessible to a plurality of client computers. Such client computers include a PC 9, a personal digital assistant 10 and a mobile telephone 11.

The server 8 and the client computers can be connected to the Internet 7 in any convenient way. For example, the server 8 may be connected to a local area network (not shown) to which a further server may also be connected. The further server may be provided with an Internet connection, and in this way the server 8 is connected to the Internet via the further server. The PC 9 can be connected to the Internet in a similar way, via a further local area network. Alternatively, the PC 9 may be provided with a modem (not shown) such that the PC 9 can establish a dial up connection to a server connected to the Internet 7, thus providing the PC 9 with access to the Internet. The PDA 10 and mobile telephone 11 can also be connected to the Internet 7 in any convenient way.

Given that the client computers and the server 8 are connected to the Internet 7, the client computers can access information provided by, and transmit information to the server 8. For example, the server 8 may provide web pages which can be accessed by the client computers running appropriate web-browser software. Those web pages may provide various forms into which users of the client computers can input data, and data so input can then be transmitted to the server 8.

In addition to providing the mobile telephone 11 with a connection to the Internet 7 and thus allowing, web pages to be obtained from the server 8 and data to be returned to the server 8, the mobile telephone can also transmit Short Messaging Service (SMS) messages. This means that the mobile telephone 11 can communicate with an SMS gateway 12 which is also connected to the Internet 7. Messages received by the SMS gateway 12 can then be provided to the server 8 via the Internet 7. For example, a particular data request can be transmitted from the mobile telephone 11 in the form of an SMS message which is received by the SMS gateway 12. The SMS gateway 12 then processes the received SMS message to generate a request which is transmitted to the server 8 via the Internet 7. Similarly, data received at the SMS gateway 12 from the server 8 is processed to generate an SMS message which is then transmitted to the mobile telephone 11. It can thus be seen that there are two ways in which the mobile telephone 11 (and indeed any device capable of sending and receiving SMS messages) can communicate with the server 8: by being provided with Internet connectivity and using this connectivity to access webpages, and by sending and receiving SMS messages.

FIG. 3 is a schematic illustration of a product distributed according to the process of FIG. 1. The product is a bottle of alcoholic beverage 13, for example a spirit such as vodka or whisky, and is thus a relatively high value product. It can be seen that the bottle 13 has a label 14 affixed thereto, the label 14 including a logo or brand name 15 identifying the bottle 13. The bottle 13 has a bottle top 16. The bottle 13 also has a further label 17 affixed thereto. The label 17 shows a product identification code 18 which identifies the particular instance of the product, preferably uniquely, and which is used by brand protection officers in the manner described below. The label 17 further features a batch identifier 19 identifying a batch in which the bottle was filled and labelled (processes which are equivalent to manufacture and packaging described with reference to FIG. 1). Finally, the bottle 13 has a hologram 20 affixed thereto, the hologram again being usable in operations intended to check the authenticity of the bottle 13 as described below.

FIG. 3A is a schematic illustration of an alternative product distributed according to the process of FIG. 1. The product is again a bottle of alcoholic beverage 13, and has many characteristics in common with the bottle shown in FIG. 3. Where appropriate, like reference numerals are used to reference like parts in each of FIGS. 3 and 3A. It can be noted, however, that the label 17 provided on the bottle shown in FIG. 3 is not provided on the bottle shown in FIG. 3A. Instead, the hologram 20 is arranged to display an graphical image 20a, as well as the product identification code 18 and the batch identifier 19.

The hologram 20 (in each of FIGS. 3 and 3A) can be produced in any convenient way. In some embodiments of the invention the hologram 20 is produced using a laser marking process. That is, the information borne by the hologram is marked using a laser-based process in which an appropriate substrate is irradiated to form the hologram. The production of the hologram 20 using a laser marking process allows the information borne by the hologram to be more easily varied between different instances of a product. This is advantageous not only in allowing the graphical image 20a included in the hologram 20 to be varied, but also in allowing the product identification code 18 and the batch identifier 19 to be included in the hologram, as shown in FIG. 3A.

A process carried out by the brand protection officer 6 (FIG. 1) to ensure the authenticity of the bottle 13 (FIG. 3 or FIG. 3A) using the computer network of FIG. 2 is now described. The process is first described with reference to a computing device running a web browser to access webpages provided by the server 8. The process is described with reference to the PDA 10, although it will be appreciated that the process can be carried out using any computing device running a webbrowser.

Referring to FIG. 4 processing carried out at the PDA 10 and the server 8 is shown in respective flowcharts, the PDA 10 and server 8 communicating via the Internet 7 as described above. The process is concerned with verifying the authenticity of a bottle 13 shown in FIG. 3 or FIG. 3A. At step Si the brand protection officer inputs a URL of a website allowing authentication operations to be carried out. A request for an appropriate webpage is transmitted to and received by the server 8, in response to which the server 8 transmits an appropriate webpage to the PDA 10 at step S2. The webpage is received by the server 8 at step S3. The received webpage provides a text box into which the product identification code 18 is input at step S4, the input product identification code being transmitted to the server 8 at step S5 by selection of an appropriate button provided by the webpage. Having transmitted the product identification code at step S5 the PDA 10 enters a loop at step S6 where it remains until further data is received from the server 8.

The product identification code 18 is received by the server 8 at step S7. The received product identification code is validated at Step S8. This validation can take any convenient form. For example, the product identification code may be decrypted using a predetermined decryption key, and the decrypted data can then be compared with data stored in a database. Alternatively, all valid identification codes may be stored and the validation of step S8 may involve a comparison between the stored identification codes and the identification code received at step S7. The exact form of the validation will depend upon the methodology selected by the brand owner for the generation of identification codes.

At step S9 a check is carried out determine whether the validation was successful. If the validation was unsuccessful, processing passes to step S10 where the server 8 transmits data to the PDA 10 indicating validation has failed. Receipt of data at the PDA 10 results in the PDA 10 exiting the loop of step S6, and processing continuing at step S11 where a check is carried out to determine the nature of received data. If it is determined that the received data indicates unsuccessful validation, processing continues at step S12 where data is presented to the user indicating unsuccessful validation.

If however the validation of step S8 is successful, processing moves from step S9 to step S13, where a plurality of questions which are to be used to verify the authenticity of the product are obtained. Such questions can be obtained based upon the identifier received at step S7 in a number of ways, some of which are described in further detail below. When questions have been obtained, they are transmitted to the PDA 8 at step S14. This results in the loop of step S6 exiting. The nature of the received data is determined at step S11, and the questions are processed by the PDA 8 at step S15 before being displayed to a user at step S16.

The questions can take any suitable form, but will relate to features of the bottle 13. For example, one or more questions may relate to a colour of the bottle, and/or one of the labels 14, 17, and/or the bottle top 16. One or more questions may relate to features of the logo or brand name 15. The bottle 13 is likely to include textual information printed on the labels 14, 15. One or more questions may relate to the formatting of such textual information. For example, one or more questions may relate to a font in which predetermined textual data (such as a use by or production date) is printed. Questions can similarly relate to a font style, that is whether predetermined textual data appears in an emboldened or italicised form. Additionally or alternatively questions can relate to punctuation used within particular textual information. That is, for example, questions can relate to the presence or absence of a full stop (period mark, “.”) at the end of particular textual information, or within an abbreviation. That is if a product is made in the USA, a question may ask a user to indicate whether the country of manufacture is shown as “USA” or “U.S.A.”. As indicated above, the bottle 13 has a hologram 20 affixed thereto. One or more questions can therefore relate to the form of that hologram (or in the case of the product shown in FIG. 3A, the form of the graphical image 20a included in the hologram 20). For example an image indicating a graphical image displayed in an authentic hologram may be displayed and a user may be asked to indicate whether the bottle 13 bears a hologram comprising a matching graphical image. Alternatively a textual description of an authentic hologram may be provided and a user asked to indicate whether the bottle 13 bears a hologram comprising a graphical image matching the textual description. Alternatively, a textual list of image features may be provided (e.g. a list of shapes) and a user asked to select one of the image features included in the hologram from the list.

Each question is preferably presented together with a plurality of possible answers from which a user is invited to select. That is, in addition to retrieving and providing the questions themselves, the server 8 additionally provides a plurality of possible answers which are displayed for user selection at step S16. Such answers may take a textual or pictorial form. For example, if a question relates to the hologram it may present a sample graphical image and ask a user to indicate whether the hologram 20 carries a graphical image which matches the displayed sample graphical image. Alternatively, a question may ask the user to select which of a plurality of displayed graphical images most closely matches the graphical image carried by the hologram 20. In such a case, it is preferred that an option is presented which a user can select to indicate that the graphical image carried by the hologram 20 does not match any of the presented holograms.

Referring again to FIG. 4, received questions together with possible answers are displayed to a user at step S16 as described above. A user selects answers from the possible answers using the PDA 10 at step S17. Such answers are then appropriately encoded and transmitted to the server 8 at step S18.

The transmitted answers are received by the server 8 at step S19, and the server 8 retrieves appropriate answers from a database at step S20. Retrieval of answers is based upon the product identification code received by the server 8 at step S7, and takes a similar form to retrieval of questions at step S13. Indeed, in some embodiments of the invention, answers can be retrieved at step S13 together with the questions, and stored in memory pending receipt of answers from the PDA 10.

Having retrieved answers at step S20, the retrieved answers are compared with the answers received at step S19 at step S21. The comparison indicates whether the product 13 is infact authentic. This indication is based upon validation of the product identification code at step S8 (as described above), and further based upon answers provided to the presented questions. That is, in order to be found authentic, not only is the product identification code checked to be valid, additionally, features of the product such as those described above, are compared with stored data to ensure that the product has the expected features. In this way, counterfeit activity is made considerably more difficult, given that a counterfeiter need not only provide a valid identification code, but also needs to ensure that product features match those stored. The result of authentication is transmitted from the server 8 at step S22 and received by the PDA 10 at step S23.

In alternative embodiments of the invention, questions to be answered relating to product features can be provided to brand protection officers (or other users) in advance in some convenient way (for example by email, by access to a website, or on paper). When a product is to be checked for authenticity, appropriate answers to these questions can then be communicated to the server 8 in any suitable way. One example is shown in FIG. 5.

Referring to FIG. 5 a brand protection officer creates an SMS message containing the product identification code, followed by an ordered list of answers to the provided questions using the mobile telephone 11 at step S30. This SMS message is then transmitted from the mobile telephone 11 to the SMS gateway 12 at step S31, from where appropriate data is transmitted to the server 8 at step S32. Such validation is carried out at the server 8 at step S33. The validation includes both validation of the provided product identification code, and validation of the provided answers, broadly as described above with reference to FIG. 4. Appropriate data indicating the result of validation is provided from the server 8 to the SMS gateway 12 at step S34. The SMS gateway 12 then creates an SMS message at step 35, indicating the result of validation, which SMS message is transmitted to the mobile telephone 11 at step S36.

It has been described above that based upon the provided product identification code, appropriate questions and answers are retrieved by the server 8. Such retrieval is now described in further detail with reference to FIGS. 6 to 8.

Referring first to FIG. 6, processing carried out to obtain appropriate questions based upon a particular product identification code is now described. At step S40 the product identification code of interest is obtained. This product identification code is processed at step S41 to obtain a batch identifier of a batch with which the product having the processed identification code is associated. The processing of step S41 can take any convenient form. For example, it may be that the product identification code received at step S40 is in an encrypted form, so that a decryption operation is carried out step S41 to obtain the necessary batch identifier.

Having obtained the necessary batch identifier at step S41, this is used to carryout a database lookup operation to obtain appropriate questions. Similarly, at step S43 appropriate answers to the retrieved question are obtained so as to allow answers to be displayed alongside the questions as described above.

The processing of steps S40 to S43 described above generally corresponds to the processing of step S13 of FIG. 4. Having obtained appropriate questions and answers in this way, these questions together with the answers can be transmitted to the PDA 10 at step S14.

FIGS. 7A and 7B show database tables used in the processing of FIG. 6. FIG. 7A shows a questions table having a Batch ID field, a Question ID field and a Question Text field. Storing data in the table of FIG. 7a in this way means that a particular batch identifier obtained at step S41 can be processed so as to obtain particular questions associated with products within that batch. Specifically, a given Batch ID may be used to query the questions table of FIG. 7A so as to obtain a plurality of questions at step S42.

Similarly, having obtained appropriate questions, data stored in the Question ID field of each question to be asked can be used to lookup appropriate records of the answers table of FIG. 7B. It can be seen that the answers table of FIG. 7B has a Question ID field allowing the described lookup to take place, as well as a field defining a possible answer and an indication of whether that answer is correct. That is, for a particular question within the questions table of FIG. 7A a plurality of records will exist in the answers table of FIG. 7B. The records of the answers table FIG. 7B for a particular question will represent all options which are to be presented to a user. It can be seen that the answers table of FIG. 7B includes a correct field taking a Boolean value indicating whether a particular answer is correct. That is, a particular question will be associated with a plurality of records of the answers table of FIG. 7B, all but one of those records having a value of false stored in its correct field, and one of the records having a value of true stored in its correct field.

The preceding description with reference to FIGS. 6, 7A and 7B shows how appropriate question data can be stored and retrieved so as to display questions and appropriate answers to a user.

Referring now to FIG. 8, the processing of step S19 of FIG. 4 where answers are received from a user is again shown. It can be seen that when appropriate answers have been received a temporary array of those answers is created at step S45. This array will indicate which of the plurality of presented options has been selected by a user. This data can be compared against data stored in the answers table of FIG. 7B to determine whether a user is provided correct answers.

It will be appreciated that although the processing of FIGS. 6, 7 and 8 has been described with reference to processing questions and answers with reference to a batch identifier this need not necessarily be the case. Indeed, in some embodiments of the present invention specific questions and answers may be stored for each product identification code, that is for each instance of a particular product. This adds considerable security to the system, although this is of course achieved at a considerable storage overhead.

It has been described above how by performing authentication based not only upon an identification code, but based also upon product features, more robust authentication is achieved. Validation of product features as described above has been concerned with receiving data items relating to product characteristics (for example in the form of answers to particular questions) and processing these data items. Alternative authentication methods based upon product characteristics having the form of graphical data printed on or affixed to a product are now described, with reference to FIG. 9.

At step S50 of FIG. 9 a product identification code is received in the manner described above. In response to a receipt of such an identification code the server 8 obtains graphical data associated with that identification code. The retrieval of this graphical data can take any convenient form. For example, it may be that a batch identifier is derived from the product identification code, the batch identifier then being used to perform a database lookup to obtain the necessary graphical data. Having obtained graphical data in this way at step S51, the retrieved graphical data is composed to form a webpage at step S52 which is transmitted to a client computing device such as the PDA 10 at step S53.

The graphical data obtained and composed into webpages can take any convenient form. For example, it may be that if it is know that a product having a particular product identification code should include a hologram of predetermined form the data retrieved may be an illustration of that hologram which is presented to a user. Similarly, where the product has textual data printed thereon (for example indicating the country of manufacture) the retrieved and presented data may indicate a way in which this textual data is formatted. For example, as indicated above, the presence or absence of punctuation marks may be shown.

Indeed, in general terms, the nature of the data presented on the webpage composed at step S52 will be similar to the data to which the questions described above relate. Upon receipt of the webpage at a client computing device it will be appreciated that an interested party can review the presented information and compare the presented information with the product to carry out authentication operations.

Thus, embodiments of the invention provide two ways in which authentication can be carried out: either by asking questions of a user and processing answers to those questions to determine authentication or otherwise, or alternatively obtaining appropriate data and presenting this to a user so that a user can compare the presented data with a particular product. Although both methods are advantageous in respective circumstances it is preferred to present a plurality of questions to a user and process received answers. This is because such an approach provides added security.

Statistical data relating to verification operations may be collated and analysed. For example, the server 8 may be configured to monitor the number of verification operations carried out, and to collate results from these verification operations. In this way, the number of counterfeit products in circulation can be estimated, and characteristics of such counterfeit products can be recorded and analysed.

Although some processes described above have been described as being carried out by a brand protection officer, it will be appreciated that in alternative embodiments of the present invention the consumer could carry out similar processing as an additional or alternative check as to authenticity. Indeed, processing to determine authenticity can be carried out by any user. Similarly, when processing has been described with reference to a particular computing device (for example the PDA 10), it will be appreciated that such processing could be carried out using any suitable computing device.

The preceding description has been concerned with exemplary embodiments of the invention, it will be appreciated that various modifications can be made to the described embodiments without departing from the spirit and scope of the present invention.

1. A computer-implemented method of verifying the authenticity of a product, the method comprising: receiving an identification code associated with said product;
receiving at least one data item, the or each data item relating to a respective characteristic of said product; processing said identification code to determine at least one characteristic associated with said identification code; and generating output data indicating the authenticity of said product by processing said at least one data item relating to a characteristic of said product and said at least one characteristic associated with said identification code.

2. A method according to claim 1, wherein one characteristic of said product is a characteristic of packaging of said product.

3. A method according to claim 1, further comprising: providing prompt data indicating at least one required data item, and receiving the at least one data item in response to said prompt data.

4. A method according to claim 3, wherein each data item is associated with a respective prompt data item, each prompt data item comprising a plurality of user selectable options, wherein the or each data item is generated by user selection of an option associated with a respective one of said at least one prompt data items.

5. A method according to claim, wherein processing said identification code to determine at least one characteristic associated with said identification code comprises obtaining said at least one characteristic from a database.

6.-9. (canceled)

10. A method according to claim 1, wherein said output data indicates that said product is authentic if but only if the or each data item relating to a respective characteristic of said product matches a corresponding characteristic associated with the identification code.

11. A method according to claim 1, wherein one data item of the at least one data items relates to a colour of at least one of: said product, a part of said product, packaging of said product, and a part of packaging of said product.

12. A method according to claim 1, wherein one data item of the at least one data items relates to a form of graphical data printed on or affixed to the product.

13. A method according to claim 12, wherein said graphical data comprises a hologram, and said one data item of the at least one data items comprises data describing said hologram.

14. (canceled)

15. (canceled)

16. A method according to claim 1, wherein the product includes an interference pattern arranged to form an image.

17. A method according to claim 16, wherein said image is a holographic image.

18. (canceled)

19. (canceled)

20. A method according to claim 16, wherein said interference pattern is produced by irradiation of a substrate.

21. (canceled)

22. A method according to claim 1, further comprising: processing said identification code to validate said identification code.

23. A method according to claim 22, wherein processing said identification code comprises decrypting at least part of said identification code.

24. A method according to claim 22, wherein if said processing determines that said identification code is valid said output data is generated by said processing of said at least one data item relating to a characteristic of said product and said at least one characteristic associated with said identification code, or if said processing determines that said identification code is not valid, output data is generated based upon said validating.

25. (canceled)

26. A method according to claim 1, wherein said identification code and said at least one data item are received from a mobile computing device.

27. A method according to claim 26, wherein said identification code and said at least one data item are received at a server, the method further comprising:
transmitting said identification code and said at least one data item from a remote computer to the server.

28.-31. (canceled)

32. A computer apparatus for verifying the authenticity of a product, the apparatus comprising: a memory storing processor readable instructions; and a processor configured to read and execute instructions stored in said memory; wherein said processor readable instructions are configured to cause the processor to carry out a method according to claim 1.

33. A method of verifying the authenticity of a product, the method comprising:
transmitting an identification code associated with said product to a server;
transmitting at least one data item to said server, the or each data item relating to a respective characteristic of said product, said server being configured to process said identification code to determine at least one characteristic associated with said identification code, and to generate said output data indicating the authenticity of said product by processing said at least one data item relating to a characteristic of said product and said at least one characteristic associated with said identification coder;
and receiving data indicating the authenticity of said product from said server.

34. (canceled)

35. A method of verifying the authenticity of a product, the method comprising:
receiving a plurality of prompt data items at a client from a server, each prompt data item requesting a data item relating to a characteristic of said product;
transmitting a plurality of data items from said client to said server, each data item relating to a respective characteristic of said product and being generated in response to a respective prompt data item;
transmitting an identification code associated with said product from said client to said server;
receiving said identification code and said at least one data item at said server processing said identification code at said server to determine at least one characteristic associated with said identification code; and
generating output data at said server indicating the authenticity of said product by processing said at least one data item relating to a characteristic of said product and said at least one characteristic associated with said identification code.

36.-42. (canceled)
